(19) United States
(12) Patent Application Publication
(10) Pub. No.: US 2023/0396537 A1
(43) Pub. Date: Dec. 7, 2023

(54) MACRO-FLOW GENERATION APPARATUS, MACRO-FLOW GENERATION METHOD AND PROGRAM

(71) Applicant: NIPPON TELEGRAPH AND TELEPHONE CORPORATION, Tokyo (JP)

(72) Inventors: Masahiro KOBAYASHI, Tokyo (JP); Shigeaki HARADA, Tokyo (JP); Taichi KAWANO, Tokyo (JP)

(21) Appl. No.: 18/250,046

(22) PCT Filed: Oct. 26, 2020
(86) PCT No.: PCT/JP2020/040060

§ 371 Date: Apr. 21, 2023

(51) Int. Cl. H04L 45/00

(52) U.S. Cl. CPC H04L 45/38

(57) ABSTRACT

A macro-flow generation apparatus includes: a macro-flow generation unit that divides, for individual flows of each of a plurality of terminals which use a service provided via a network, a set of a plurality of individual flows into macro-flows each of which includes one or more of the individual flows based on a similarity of requested qualities of the plurality of the individual flows, the requested qualities being collected from each of the terminals; and a macro-flow requested-quality calculation unit that calculates, for each of the macro-flows, a requested quality of the macro-flow based on requested qualities of one or more of the individual flows belonging to the macro-flow. Thereby, it is possible to generate a macro-flow capable of reducing a possibility that path assignment causing a deterioration in communication quality is performed.

### TECHNICAL FIELD

The present invention relates to a macro-flow generation apparatus, a macro-flow generation method, and a program.

### BACKGROUND ART

In recent years, a software defined network (SDN) technique represented by OpenFlow has been introduced in a communication network. In the SDN, a flow is defined by a certain combination of header information such as a transmission/reception IP address, a transmission/reception port number, and a protocol number, and a path can be controlled in units of flows. In addition, a controller can centrally control each node in a network by software, and thus it is possible to implement control with a finer size and a shorter time period as compared with traffic control in the related art such as OSPF.

On the other hand, each node and the controller need to hold path information in units of flows, and the number of pieces of information to be managed is enormous. As a result, it is difficult to apply the SDN to a large-scale network. For this reason, a technique of controlling traffic with a size larger than a size of an individual flow and smaller than a size in a case where network addresses are the same has been proposed (for example, Patent Literature 1 and Non Patent Literature 1). Specifically, some flow groups are integrated from a flow set including the same transmission/reception network address, and the path is controlled in units of the integrated flow groups. Hereinafter, the individual flow is referred to as a “micro-flow”, and the integrated flow groups are referred to as a “macro-flow”.

In the technique of Patent Literature 1, a macro-flow is generated such that a time-series variation in communication amount is decreased. In addition, in Non Patent Literature 1, a macro-flow is generated such that access patterns (requested communication qualities) are similar.

### CITATION LIST

### Patent Literature

Patent Literature 1: JP 2015-156529 A
Patent Literature 2: WO 2017/082185 A

### Non Patent Literature

Non Patent Literature 1: Yuka KOMAI, Tatsuaki KIMURA, Masahiro KOBAYASHI, and Shigeaki HARADA, “Traffic Prediction Method based on Access Patterns”, IEICE Technical Report, vol. 119, no. 158, IN2019-22, pp. 43-46, August 2019
Non Patent Literature 2: Kobayashi et al., “Network Control Technique based on Service Request Communication Quality”, IEICE General Convention, March 2020

### SUMMARY OF INVENTION

### Technical Problem

In the technique in the related art for generation of the macro-flow, a macro-flow can be generated. On the other hand, a requested communication quality (a requested band, a requested delay, or the like) for each macro-flow is not estimated. In the traffic control technique (for example, Patent Literature 2), path assignment is calculated so as to satisfy a requested communication quality in units of control. For this reason, in a case where a requested communication quality for each macro-flow is not clear, path assignment in which a requested communication quality is not considered is performed. As a result, a communication quality of a flow may be greatly lowered. Thus, as a method of estimating a requested communication quality of a macro-flow from requested communication qualities of micro-flows, Non Patent Literature 2 proposes a method of setting a statistical value (an average value, a median value, a maximum/minimum value, a percentage value, or the like) of the requested communication qualities of the micro-flows configuring the macro-flow, as a requested communication quality of the macro-flow.

By combining the techniques in the related art for generation of the macro-flow, estimation of the requested quality of the macro-flow, and traffic control, network control based on the macro-flow can be performed. However, the techniques are executed according to states of terminals and states of users based on traffic information which can be acquired from the network. As a result, there is a possibility that path assignment causing a degradation in communication quality is performed.

The present invention has been made in view of the above points, and an object of the present invention is to generate a macro-flow capable of reducing a possibility that path assignment causing a deterioration in communication quality is performed.

### Solution to Problem

Therefore, in order to solve the above problem, there is provided a macro-flow generation apparatus including: a macro-flow generation unit that divides, for individual flows of each of a plurality of terminals which use a service provided via a network, a set of a plurality of individual flows into macro-flows each of which includes one or more of the individual flows based on a similarity of requested qualities of the plurality of the individual flows, the requested qualities being collected from each of the terminals; and a macro-flow requested-quality calculation unit that calculates, for each of the macro-flows, a requested quality of the macro-flow based on requested qualities of one or more of the individual flows belonging to the macro-flow.

### Advantageous Effects of Invention

It is possible to generate a macro-flow capable of reducing a possibility that path assignment causing a deterioration in communication quality is performed.

### BRIEF DESCRIPTION OF DRAWINGS

FIG. 1 is a diagram illustrating a system configuration example according to an embodiment of the present invention.

FIG. 2 is a diagram illustrating a hardware configuration example of a macro-flow generation apparatus 10 according to the embodiment of the present invention.

FIG. 3 is a diagram illustrating a functional configuration example of the macro-flow generation apparatus 10 according to the embodiment of the present invention.

FIG. 4 is a diagram for explaining processing executed by a micro-flow requested-quality calculation unit 11.

FIG. 5 is a diagram for explaining processing executed by a macro-flow generation unit 12.

FIG. 6 is a diagram for explaining processing executed by a macro-flow requested-quality calculation unit 13.

FIG. 7 is a diagram for explaining processing executed by a macro-flow regeneration unit 14.

FIG. 8 is a flowchart for explaining an example of a processing procedure of macro-flow regeneration processing.

### DESCRIPTION OF EMBODIMENTS

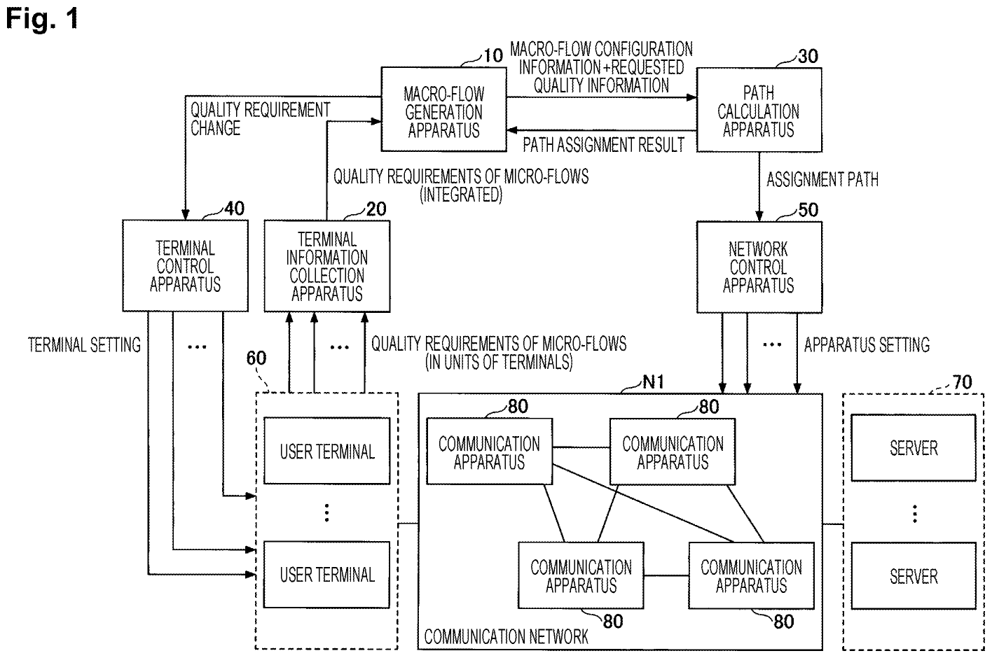

Hereinafter, an embodiment of the present invention will be described with reference to the drawings. FIG. 1 is a diagram illustrating a system configuration example according to an embodiment of the present invention. FIG. 1 illustrates a communication network N1, one or more user terminals 60, one or more servers 70, a terminal information collection apparatus 20, a macro-flow generation apparatus 10, a path calculation apparatus 30, a terminal control apparatus 40, a network control apparatus 50, and the like.

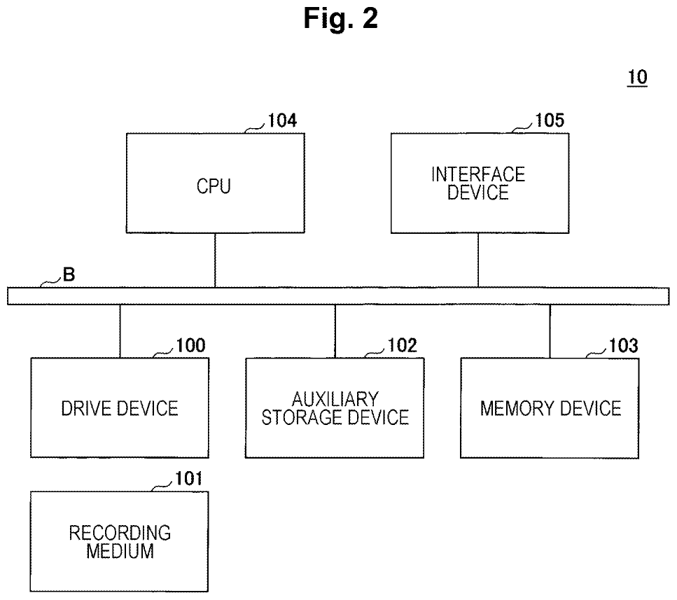

The communication network N1 is a communication network that transfers traffic in communication between the user terminal 60 and the server 70. As illustrated in FIG. 2, the communication network N1 includes a plurality of communication apparatuses 80. The communication apparatus 80 is an apparatus that transfers traffic such as a router and a switch.

The user terminal 60 and the server 70 are apparatuses serving as a traffic transmission source or a traffic transmission destination. The server 70 is a computer that provides a service by a service provider to the user terminal 60 via the communication network N1. The user terminal 60 is a terminal (for example, a personal computer (PC), a tablet terminal, a smartphone, or the like) used by a user who uses the service. In the user terminal 60, an application of a service provider cooperating with a network provider is installed. The application acquires a quality requirement for each micro-flow. Note that, in the present embodiment, a micro-flow refers to an individual flow defined by a certain combination of header information such as transmission/reception IP addresses, transmission/reception port numbers, and a protocol number in a software defined network (SDN). On the other hand, a flow group obtained by integrating some flow groups from a flow set having the same transmission/reception network addresses is referred to as a “macro-flow”.

The terminal information collection apparatus 20 is an apparatus that collects, from each user terminal 60, a quality requirement for each micro-flow acquired by the user terminal 60 (the application). The quality requirement refers to a requirement desired by the user of the user terminal 60 for a service quality (or a communication quality related to a service).

The macro-flow generation apparatus 10 is one or more computers that generate a macro-flow and calculate (estimate) a requested quality of the macro-flow based on the quality requirement of each micro-flow collected by the terminal information collection apparatus 20. The macro-flow generation apparatus 10 transmits information indicating the micro-flows which configure the generated each macro-flow (hereinafter, referred to as “macro-flow configuration information”) and the requested quality of the macro-flow to the path calculation apparatus 30.

The path calculation apparatus 30 sets the macro-flow configuration information and the requested quality of each macro-flow as requested conditions, and calculates a path to be assigned to each macro-flow (executes path assignment in units of macro-flows). For example, a technique proposed in Patent Literature 2 or the like may be applied to the path calculation apparatus 30. The path calculation apparatus 30 notifies the macro-flow generation apparatus 10 of a result as a path assignment result indicating a success or a failure of path assignment in units of macro-flows. In a case where the path assignment result indicates that path assignment satisfying the requested qualities of all the macro-flows cannot be performed, the macro-flow generation apparatus 10 regenerates (reconfigures) the macro-flow so as to increase a possibility of a success of the path assignment. In a case where network resources are tight and the path assignment cannot be successfully performed regardless of how the macro-flow is regenerated with the current quality requirements of the micro-flows, the macro-flow generation apparatus 10 performs control to change the quality requirements of some or all of the micro-flows. Specifically, the macro-flow generation apparatus 10 requests the terminal control apparatus 40 to change (lower) the quality requirements of some or all of the micro-flows.

The terminal control apparatus 40 requests the application of each user terminal 60 to change the quality requirement of the micro-flow according to the change request of the quality requirement of the micro-flow from the macro-flow generation apparatus 10. By the request, it is possible to reduce traffic of a service requesting high quality and to increase a possibility of a success of the path assignment.

The network control apparatus 50 sets traffic transfer information for each communication apparatus 80 based on the assignment path of the macro-flow that is calculated by the path calculation apparatus 30. Note that, for traffic for which feedback from the user terminal 60 cannot be obtained, macro-flow control may be executed using traffic information that can be acquired from the communication network N1 by a technique in the related art for generation of the macro-flow (Patent Literature 1 and Non Patent Literature 1) and estimation of the requested quality of the macro-flow (Non Patent Literature 2).

FIG. 2 is a diagram illustrating a hardware configuration example of the macro-flow generation apparatus 10 according to the embodiment of the present invention. The macro-flow generation apparatus 10 of FIG. 2 includes a drive device 100, an auxiliary storage device 102, a memory device 103, a CPU 104, an interface device 105, and the like which are connected to each other by a bus B.

A program for implementing processing in the macro-flow generation apparatus 10 is provided by a recording medium 101 such as a CD-ROM. When the recording medium 101 storing the program is set in the drive device 100, the program is installed from the recording medium 101 to the auxiliary storage device 102 via the drive device 100. Here, the program is not necessarily installed from the recording medium 101, and may be downloaded from another computer via a network. The auxiliary storage device 102 stores the installed program and also stores files, data, and the like which are required.

In a case where an instruction to start the program is input, the memory device 103 reads and stores the program from the auxiliary storage device 102. The CPU 104 executes a function related to the macro-flow generation apparatus 10 according to the program stored in the memory device 103. The interface device 105 is used as an interface for connection to a network.

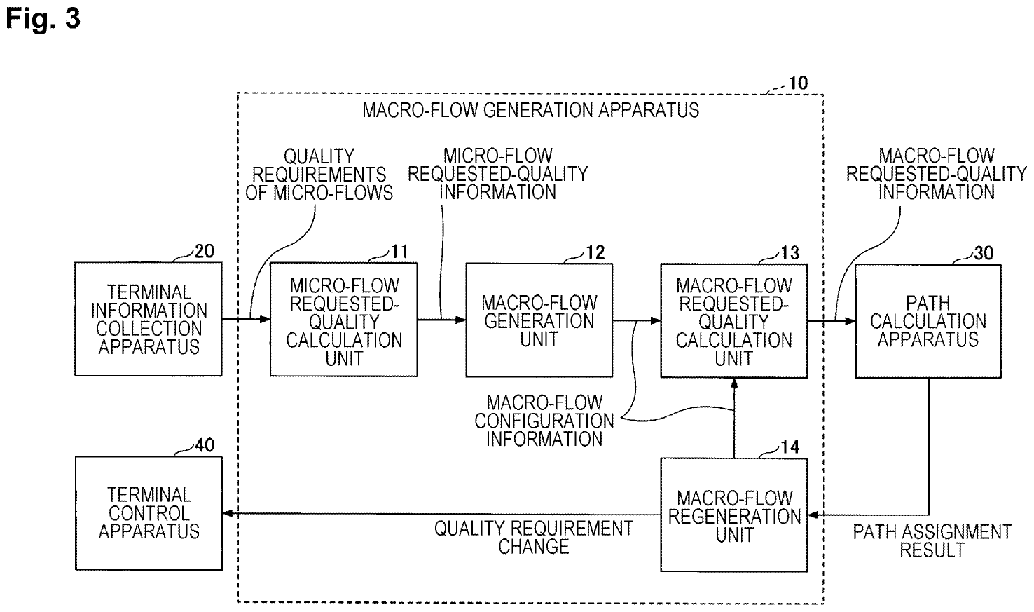

FIG. 3 is a diagram illustrating a functional configuration example of the macro-flow generation apparatus 10 according to the embodiment of the present invention. In FIG. 3, the macro-flow generation apparatus 10 includes a micro-flow requested-quality calculation unit 11, a macro-flow generation unit 12, a macro-flow requested-quality calculation unit 13, a macro-flow regeneration unit 14, and the like. Each of these units is implemented in a case where the CPU 104 executes processing by one or more programs installed in the macro-flow generation apparatus 10.

### [Micro-Flow Requested-Quality Calculation Unit 11]

The micro-flow requested-quality calculation unit 11 calculates (generates) micro-flow requested-quality information from the micro-flow quality requirement.

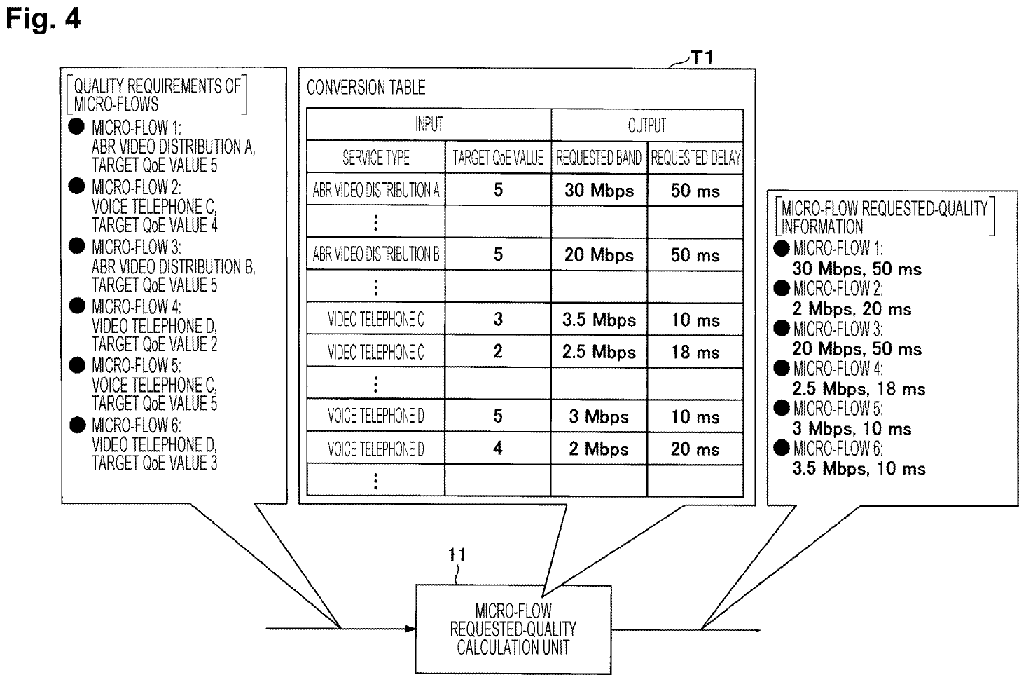

FIG. 4 is a diagram for explaining processing executed by the micro-flow requested-quality calculation unit 11. As illustrated in FIG. 4, the micro-flow quality requirement is information including, for each micro-flow, a type of a service used by the micro-flow, a target quality-of-experience (QoE, quality of experience of a user) value of the micro-flow, and the like.

A type of a service is a type of a service provided in the micro-flow.

The QoE value is a numerical value indicating a level of a quality of experience of a user that is related to a service. In the example of FIG. 4, the QoE value is evaluated in five stages, and a higher numerical value indicates better quality. The quality evaluation is standardized in services such as voice telephone (“The E-model: a computational model for use in transmission planning, Recommendation ITU-T G.107, 2015”), video telephone (“Opinion model for video-telephony applications, Recommendation ITU-T G.1070, 2018”), and adaptive bit rate (ABR) video distribution (“Parametric bitstream-based quality assessment of progressive, download and adaptive audiovisual streaming services over reliable transport, Recommendation ITU-T P.1203, 2017”), and the QoE value corresponds to a MOS value in the services.

The target QoE value is a QoE value representing a quality level requested by a user, and a higher target QoE value indicates that the user requests the service having a higher quality. For example, the target QoE value for a user who is not satisfied without a high-quality moving image is set to be higher. Further, the target QoE value for a user who considers the quality as being sufficient in a case where the content can be understood even with a low-quality moving image is set to be lower.

On the other hand, the micro-flow requested-quality information is information including a requested quality (in the example of FIG. 4, a requested band, a requested delay, and the like) for each micro-flow.

Various methods are considered to calculate the micro-flow requested-quality information from the micro-flow quality requirement. FIG. 4 illustrates a method using a conversion table T1. The conversion table T1 is stored, for example, in the auxiliary storage device 102. The conversion table T1 stores correspondence information between an input and an output in a case where a set of the service type and the target QoE value is set as the input and a requested quality which is required is set as the output. The micro-flow requested-quality calculation unit 11 specifies a requested quality for each micro-flow quality requirement included in the micro-flow requested-quality information which is input by using the conversion table T1 (converts the micro-flow quality requirement into a quality requirement), and outputs the micro-flow requested-quality information including the specified requested-quality group to the macro-flow generation unit 12.

Various methods are considered as a method of configuring the conversion table T1. As an example, a method in which a network provider cooperates with a service provider and the conversion table T1 is configured based on information provided from the service provider is considered. In addition, a method using a technique (Patent Literature 3) that models a relationship between throughput and QoE is considered. The technique is a technique of estimating QoE using a throughput as an input. In the technique, the corresponding throughput may be derived from QoE by using a correspondence relationship between the throughput of the model and QoE, and the conversion table T1 may be configured.

On the other hand, the micro-flow quality requirement which is collected from the user terminal 60 may include a requested quality (in the example of FIG. 4, a requested band, a requested delay, and the like) instead of the target OoE value. In this case, the micro-flow requested-quality calculation unit 11 may generate the micro-flow requested-quality information by simply collecting the requested qualities of each micro-flow.

### [Macro-Flow Generation Unit 12]

Based on the micro-flow requested-quality information which is output from the micro-flow requested-quality calculation unit 11, the macro-flow generation unit 12 divides a set of a plurality of micro-flows into macro-flows based on a similarity of the requested qualities, and generates macro-flow configuration information indicating a division result. Specifically, the macro-flow generation unit 12 integrates the micro-flows of which the requested qualities are similar into the same macro-flow.

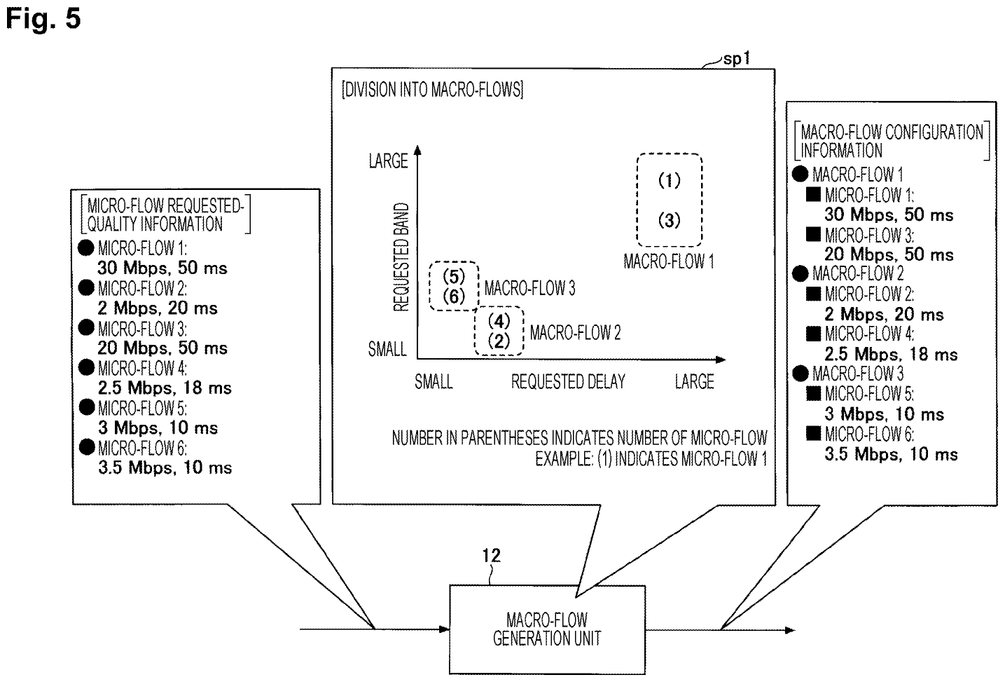

FIG. 5 is a diagram for explaining processing executed by the macro-flow generation unit 12. As illustrated in FIG. 5, the macro-flow configuration information includes, for each macro-flow, the requested quality of each micro-flow configuring the macro-flow (integrated in the macro-flow). According to the macro-flow configuration information of FIG. 5, an example in which the micro-flow group is divided into three macro-flows based on the similarities in the requested band and the requested delay is illustrated. For example, the macro-flow generation unit 12 may divide the micro-flow group into macro-flows (integrate the micro-flows of which the requested qualities are similar) by applying, to the requested quality of each micro-flow, an existing clustering technique such as a K-means method. That is, in this case, the macro-flow generation unit 12 integrates the micro-flow group, which is classified as the same cluster, into the same macro-flow. FIG. 5 illustrates an example in which clustering is performed on the micro-flow group in a two-dimensional space sp1 of the requested band and the requested delay which configure the requested quality. Note that, in the two-dimensional space sp1, a number in parentheses indicates an identification number of the micro-flow. For example, (1) indicates a micro-flow 1. The macro-flow generation unit 12 outputs the generated macro-flow configuration information to the macro-flow requested-quality calculation unit 13.

### [Macro-Flow Requested-Quality Calculation Unit 13]

The macro-flow requested-quality calculation unit 13 calculates (estimates), for each macro-flow, a requested quality of the macro-flow based on the requested quality of each micro-flow group configuring the macro-flow by referring to the macro-flow configuration information which is output from the macro-flow generation unit 12. The macro-flow generation unit 12 generates macro-flow requested-quality information based on the calculation result, and outputs the macro-flow requested-quality information.

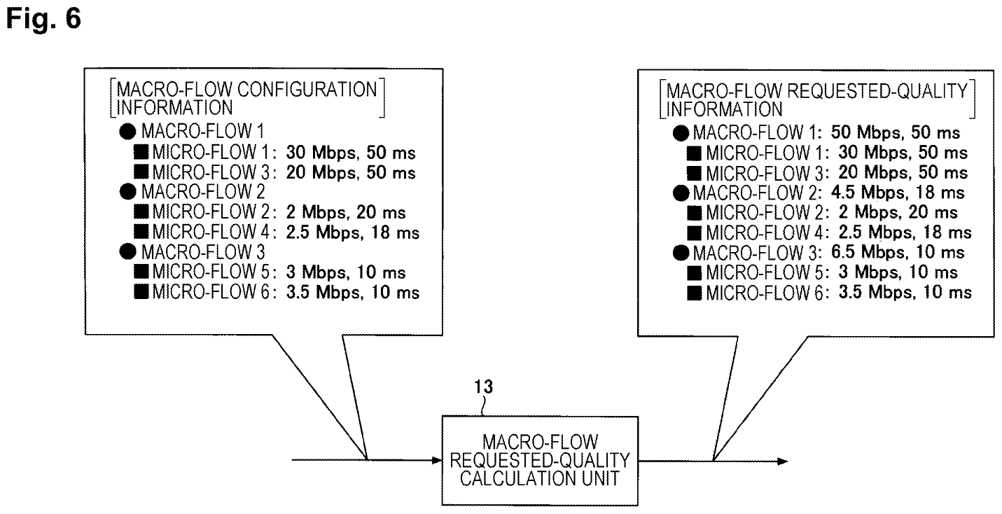

FIG. 6 is a diagram for explaining processing executed by the macro-flow requested-quality calculation unit 13. As illustrated in FIG. 6, the macro-flow requested-quality information is information including a calculation result of the requested quality for each macro-flow in addition to the macro-flow configuration information. For example, as described in Non Patent Literature 2, the macro-flow requested-quality calculation unit 13 sets a statistical value (an average value, a median value, a maximum/minimum value, a percentage value, or the like) of the requested qualities of the micro-flows configuring the macro-flow, as a requested communication quality of the macro-flow. FIG. 6 illustrates an example in which the requested band of the macro-flow is a total value of the requested bands of the micro-flows configuring the macro-flow and in which the requested delay of the macro-flow is a minimum value of the requested delays of the micro-flows. The macro-flow requested-quality calculation unit 13 transmits the macro-flow requested-quality information to the path calculation apparatus 30.

### [Macro-Flow Regeneration Unit 14]

The macro-flow regeneration unit 14 receives the path assignment result from the path calculation apparatus 30, and regenerates a macro-flow in a case where the path assignment result indicates a failure of assignment. The macro-flow regeneration unit 14 also transmits a request for changing the quality requirement of the user terminal 60 to the terminal control apparatus 40.

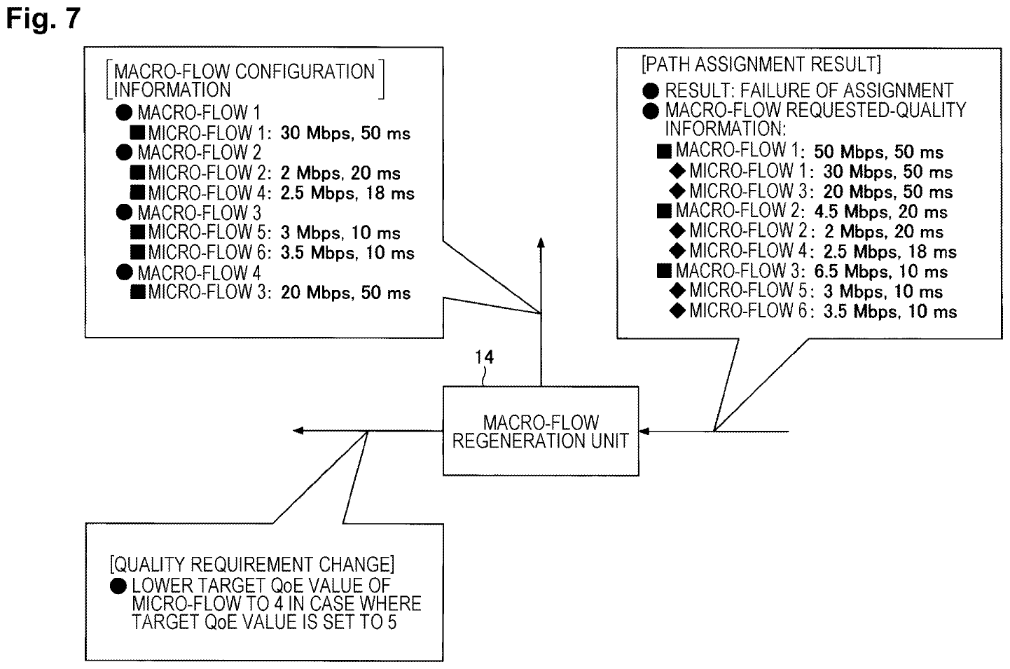

FIG. 7 is a diagram for explaining processing executed by the macro-flow regeneration unit 14. As illustrated in FIG. 7, the path assignment result includes a “result” indicating a success or a failure of the assignment and the macro-flow requested-quality information used for the path assignment. In a case where the “result” of the path assignment result indicates “failure of assignment”, the macro-flow regeneration unit 14 first regenerates (reconfigures) a macro-flow. In general, path assignment for a macro-flow of which the requested band is large is likely to fail in a network with few surplus physical resources. Thus, the macro-flow regeneration unit 14 regenerates a macro-flow by dividing the macro-flow of which the requested band is a relatively large into a plurality of macro-flows. That is, the macro-flow of which the requested quality is relatively high is preferentially divided. The macro-flow regeneration unit 14 generates macro-flow configuration information related to the regenerated macro-flow, and outputs the macro-flow configuration information to the macro-flow requested-quality calculation unit 13. FIG. 7 illustrates macro-flow configuration information in a case where a macro-flow 1 of which the requested band is largest in the macro-flow requested-quality information of the path assignment result is divided into two macro-flows of a macro-flow 1 and a macro-flow 4. Note that a minimum unit of division of the macro-flow is a micro-flow. Thus, a micro-flow 1 belongs to the macro-flow 1 after division, and a micro-flow 3 belongs to the macro-flow 4.

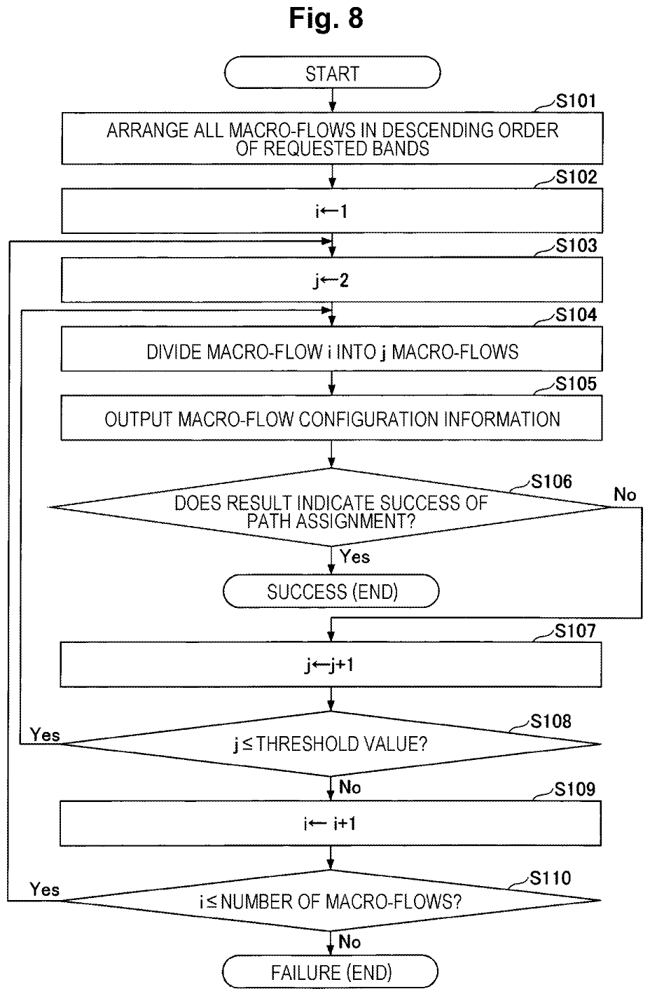

FIG. 8 is a flowchart for explaining an example of a processing procedure of macro-flow regeneration processing.

In step S101, the macro-flow regeneration unit 14 arranges all the macro-flows related to the macro-flow requested-quality information included in the path assignment result, in descending order of the requested bands of the macro-flows.

Subsequently, the macro-flow regeneration unit 14 substitutes 1 for a variable i (S102). The variable i is a variable in which the order of the macro-flow to be processed after the arrangement is stored. Hereinafter, an i-th macro-flow is referred to as a “macro-flow i”.

Subsequently, the macro-flow regeneration unit 14 substitutes 2 for a variable j (S103). The variable j is a variable in which the number of divisions of the macro-flow i is stored. That is, in the present embodiment, an initial value of the number of divisions of each macro-flow is two.

Subsequently, the macro-flow regeneration unit 14 divides the macro-flow i into j macro-flows such that the requested bands of the macro-flows after division are as equal as possible (S104). Here, “each macro-flow after division” refers to each macro-flow newly generated by division of the micro-flow group configuring the macro-flow i. At this time, as described above, a minimum unit of the division is a micro-flow configuring the macro-flow i. Thus, the requested bands of the macro-flows after division may not be completely equal. Therefore, for example, the macro-flow regeneration unit 14 divides the macro-flow i into j macro-flows such that a sum of differences between the requested bands of the macro-flows is minimized.

Subsequently, the macro-flow regeneration unit 14 outputs the macro-flow configuration information including the requested quality of each micro-flow configuring the macro-flow for each macro-flow after division and including the requested quality of each micro-flow configuring the macro-flow for each undivided macro-flow, to the macro-flow requested-quality calculation unit 13 (S105).

Thereafter, the macro-flow requested-quality calculation unit 13 calculates a requested-quality of each macro-flow based on the macro-flow configuration information, and transmits the macro-flow requested-quality information as a calculation result to the path calculation apparatus 30. The path calculation apparatus 30 calculates a path to be assigned to each macro-flow based on the macro-flow requested-quality information, and transmits a path assignment result to the macro-flow regeneration unit 14.

In a case where the path assignment result is received, the macro-flow regeneration unit 14 determines whether the “result” of the path assignment result is a value indicating a success of the path assignment (S106). In a case where the “result” is a value indicating a success of the path assignment (Yes in S106), the macro-flow regeneration unit 14 ends processing. On the other hand, in a case where the “result” is a value indicating a failure of the path assignment (No in S106), the macro-flow regeneration unit 14 adds 1 to j (S107) and determines whether a value of j is equal to or smaller than a preset threshold value (S108). Note that, in a case where the number of the macro-flows after division is too large, a significance of handling path control and the like in units of macro-flows is reduced. For this reason, the threshold value (upper limit) is set for the number of divisions of the macro-flows.

In a case where the value of j is equal to or smaller than the threshold value (Yes in S108), the macro-flow regeneration unit 14 repeats step S104 and subsequent steps. In a case where the value of j exceeds the threshold value (No in S108), the macro-flow regeneration unit 14 adds 1 to i (S109). Subsequently, the macro-flow regeneration unit 14 determines whether the value of i is equal to or smaller than the number of the macro-flows related to the macro-flow requested-quality information of the path assignment result (S110). In a case where the value of i is equal to or smaller than the number of the macro-flows (Yes in S110), the macro-flow regeneration unit 14 repeats step S103 and subsequent steps. Note that step S103 and subsequent steps are executed for each initial macro-flow (each macro-flow at the time of step S101). That is, the macro-flow generated by the division of any of the initial macro-flows is not subject to processing of step S103.

In a case where the value of i exceeds the number of the macro-flows (No in S110), the macro-flow regeneration unit 14 ends processing. In this case (that is, in a case where all the initial macro-flows are divided to the upper limit), in the current quality requirements of the micro-flows, path assignment cannot be successfully performed no matter how the macro-flow is regenerated (reconfigured). Thus, the macro-flow regeneration unit 14 transmits a quality requirement change to the application of each user terminal 60 via the terminal control apparatus 40.

The quality requirement change is information indicating an instruction on how to change the quality requirement of the user terminal 60. Various quality requirement changes may be considered. On the other hand, FIG. 7 illustrates a method of preferentially and sequentially reducing traffic of a service which requests relatively high quality so as to lower the target QoE value of the micro-flow to 4 in a case where the target QoE value is set to 5. Further, according to contracted plans of users, the quality requirement change may be generated based on a method of not lowering the target QoE for a user who has contracted for a band-reservation-type plan to be equal to or lower than a contracted band and preferentially lowering the target QoE for a user who has contracted for a best-effort-type plan.

As described above, according to the present embodiment, the quality requirement of the micro-flow that is fed back from the application is used, the application being provided by the service provider and being installed in the user terminal 60. Thereby, it is possible to generate a macro-flow capable of reducing a possibility that path assignment causing a degradation in communication quality is performed. In addition, even in a case where path assignment fails, the macro-flow is reconfigured. Thereby, it is possible to further prevent a deterioration in communication quality. As a result, it is possible to expect improvement in quality of experience of a user.

Further, in the present embodiment, in a case where path assignment fails even though the macro-flow is reconfigured, control is performed to lower the quality requirements of some or all of the plurality of micro-flows. Also in this regard, it is possible to generate a macro-flow capable of reducing a possibility that path assignment causing a deterioration in communication quality is performed.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Macro-flow generation apparatus
11 Micro-flow requested-quality calculation unit
12 Macro-flow generation unit
13 Macro-flow requested-quality calculation unit
14 Macro-flow regeneration unit
20 Terminal information collection apparatus
30 Path calculation apparatus
40 Terminal control apparatus
50 Network control apparatus 50
60 User terminal
70 Server
100 Drive device
101 Recording medium
102 Auxiliary storage device
103 Memory device
104 CPU
105 Interface device
B Bus
N1 Communication network
T1 Conversion table

1. A macro-flow generation apparatus comprising:
a memory; and
a processor coupled to the memory and configured to
divide, for individual flows of each of a plurality of terminals which use a service provided via a network, a set of a plurality of individual flows into macro-flows each of which includes one or more of the individual flows based on a similarity of requested qualities of the plurality of the individual flows, the requested qualities being collected from each of the terminals; and
calculate, for each of the macro-flows, a requested quality of the macro-flow based on requested qualities of one or more of the individual flows belonging to the macro-flow.

2. The macro-flow generation apparatus according to claim 1, wherein the processor is further configured to
regenerate the macro-flows by dividing some or all of the macro-flows in a case where path assignment fails, the path assignment being performed in units of the macro-flows based on the requested quality of each of the macro-flows.

3. The macro-flow generation apparatus according to claim 2, wherein the processor is configured to perform control to change the requested qualities of some or all of the plurality of individual flows in a case where the path assignment fails, the path assignment being performed for each of the regenerated macro-flows based on the calculated requested quality of each of the macro-flows.

4. The macro-flow generation apparatus according to claim 2, wherein the processor is configured to preferentially divide the macro-flow of which the requested quality is relatively high.

5. The macro-flow generation apparatus according to claim 1, wherein the processor is configured to generate, for each of the macro-flows, macro-flow configuration information including the requested qualities of the individual flows belonging to the macro-flow, and generate macro-flow requested-quality information obtained by adding the requested quality of the macro-flow to the macro-flow configuration information.

6. A macro-flow generation method executed by a computer, the method comprising:
dividing, for individual flows of each of a plurality of terminals which use a service provided via a network, a set of a plurality of individual flows into macro-flows each of which includes one or more of the individual flows based on a similarity of requested qualities of the plurality of the individual flows, the requested qualities being collected from each of the terminals; and
calculating, for each of the macro-flows, a requested quality of the macro-flow based on requested qualities of one or more of the individual flows belonging to the macro-flow.

7. A non-transitory computer-readable recording medium storing a program causing a computer to function as the macro-flow generation apparatus according to claim 1.
